(19) United States
(12) Patent Application Publication
(10) Pub. No.: US 2023/0295542 A1
(43) Pub. Date: Sep. 21, 2023

(54) BREW COMPONENT OF A BREWING SYSTEM

(71) Applicant: Unique Bavarian Brewery, LLC, Castle Pines, CO (US)

(72) Inventors: Michael Anthony Lentz, Bangkok (TH); Wilhelm Trappe, Vienna (AT); Paramase Pholphanich, Nonthaburi (TH); Onnicha Boonsavapark, Pathum Thani (TH)

(21) Appl. No.: 18/186,928

(22) Filed: Mar. 20, 2023

Related U.S. Application Data
(60) Provisional application No. 63/321,479, filed on Mar. 18, 2022.

(51) Int. Cl. C12C 7/06; C12C 7/04

(52) U.S. Cl. CPC C12C 7/062; C12C 7/042

(57) ABSTRACT

A component of a brewing system is provided, comprising a tank; a rotary arm disposed within the tank; an inlet pipe coupled with the rotary arm; and an outlet pipe coupled with a fluid coupling system of the brew system. Additionally, a brewing system is provided, which comprises: a first and a second tank, and a fluid coupling system between the first and second tank, the first tank including: an inner cylinder and an outer cylinder; a rotary arm; an inlet pipe fluidly coupled with the rotary arm; and an outlet pipe. Further, a method is provided, comprising: receiving water into the first tank; boiling the water; receiving malt into the first tank; mashing the malt to form a mash; transferring the mash out of the first tank; receiving wort into the first tank; boiling the wort within the first tank; and transferring the wort out of the first tank.

### CROSS-REFERENCE TO RELATED APPLICATION

This application claims priority to U.S. Provisional Application No. 63/321,479, titled “Brewing System,” filed on Mar. 18, 2022, the entire disclosure of which is hereby incorporated by reference in its entirety.

### BACKGROUND

Brewing beverages, for example brewing beer, is typically a laborious process that requires several individually conducted steps and large equipment for conducting these steps. The brewing process may be composed of the steps of mashing a milled grain to create a mash, boiling the mash, lautering the mash to form wort and spent grains, clarifying the wort, and fermenting the resulting clarified wort. In typical brewing processes, the equipment required to accomplish these steps may be expensive and occupy a large floor space. The process may additionally require qualified brewing technicians and cleaning staff.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In an example, a component of a brewing system having an outer housing enclosing at least the component and a fluid coupling system is provided. The component comprises a tank including an inner cylinder disposed at least partially within an outer cylinder; a rotary arm disposed within an upper portion of the tank; an inlet pipe coupled with the rotary arm; an outlet pipe fluidly coupled with the fluid coupling system of the brew system; and wherein the tank component is configured for creating a mash.

In another example, a brewing system is provided. The brewing system comprises: a first tank arranged distal to a second tank and a fluid coupling system arranged between the first tank and the second tank, the first tank including: an inner cylinder disposed at least partially within an outer cylinder; a rotary arm arranged within an upper portion of the first tank; an inlet pipe fluidly coupled with the rotary arm and the fluid coupling system; an outlet pipe fluidly coupled with the fluid coupling system; and wherein the first tank has a volumetric capacity of approximately 240 liters.

In a further example, a method of brewing a beverage using a brewing system is provided. The method comprises: receiving water into the first tank; boiling the water within the first tank; receiving malt into the first tank; mashing the malt to form a mash; transferring the mash out of the first tank; receiving wort into the first tank; boiling the wort within the first tank; and transferring the wort out of the first tank.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF FIGURES

Non-limiting and non-exhaustive examples are described with reference to the following Figures.

FIG. 1 illustrates a top perspective view of the brewing system.

FIG. 2 illustrates a top perspective view of a portion of an exemplary brewing system including various of an internal components of the brewing system.

FIG. 3 illustrates a top view of an exemplary brewing system without covers arranged over first and second tanks.

FIG. 4A illustrates a cross-sectional view of an exemplary brewing system including a first tank.

FIG. 4B illustrates an additional cross-sectional view of a first tank.

FIG. 5 illustrates an exploded view of an inner cylinder and the outer cylinder.

FIG. 6A is a top perspective view of the inner cylinder base of FIG. 5.

FIG. 6B illustrates a cross sectional view of the inner cylinder base of FIG. 5.

FIG. 7 illustrates a cross-sectional side perspective view of an inlet pipe for an exemplary brewing system.

FIG. 8 illustrates an exploded view of a rotary arm for an exemplary brewing system.

FIG. 9 illustrates a cross sectional view of the coupling between the inlet pipe and the rotary arm of FIG. 8.

FIG. 10 is a flow chart illustrating a method of using a first tank during a brewing process of a liquid, for example during the process of brewing beer.

### DETAILED DESCRIPTION

Various aspects of the disclosure are described more fully below with reference to the accompanying drawings, which forms a part hereof, and which show specific example aspects. However, different aspects of the disclosure may be implemented in many different ways should not be construed as limited to the aspects set forth herein. The following detailed description is, therefore, not to be taken in a limiting sense.

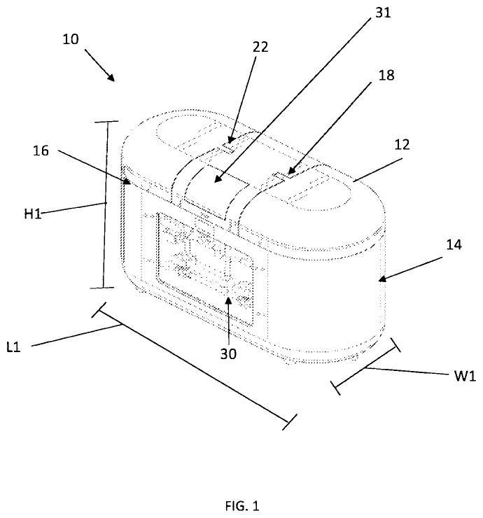

The present embodiment presents a brewing system 10 for use in brewing liquid, for example, for brewing beer. While described throughout as being used for brewing beer, various other liquids may be produced within the brewing system 10. FIG. 1 illustrates a top perspective view of the brewing system 10, which is defined by a generally rounded rectangular shape. More particularly, the brewing system 10 comprises an outer housing 12 that includes a generally rectangular portion and at least two rounded portions arranged on either end of the rectangular portion. As will be described further herein, the rounded portions may be configured for housing a plurality of tanks within the outer housing 12. As illustrated, the brewing system 10 has a length L1 of approximately 230 cm and a height of approximately 155 cm. The height may be defined as a total height of the brewing system 10 from the bottommost surface to a topmost surface. Additionally, the brewing system 10 may have a width of approximately 100 cm. In embodiments, the length L1 may be approximately 7 feet, the width W1 may be approximately 2 feet, and the height H1 may be approximately 5 feet. As a result, the brewing system 10 may cover a ground or floor area of approximately 2.5 m². However, the values provided herein for the above described dimensions of the brewing system 10 are provided as examples and other values may be incorporated. For example, the length L1, the width W1 and the height H1 may all vary depending on the size desires and/or constraints of the brewing system 10.

Further, as will be described further herein, the outer housing 12 may hold a volume of liquid of approximately 30 L to 200 L. In other words, up to 200 L of beer may be brewed at a time within the brewing system 10. However, various other values of liquid may be supported within the brewing system 10 and the above values are provided merely for example. Additionally, the brewing system 10 may be composed of various materials, such as stainless steel and/or titanium. However, various other materials may be incorporated. The weight of the brewing system 10 may be approximately 600 kg to 840 kg. In further embodiments, depending on the materials used, the weight of the brewing system 10 may be less than or greater than the provided example range.

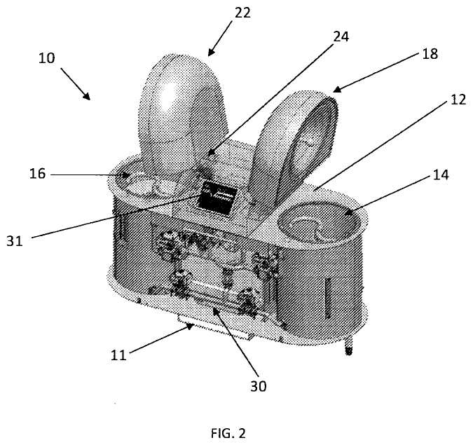

FIG. 2 illustrates a top perspective view of a portion of the brewing system 10, and more particularly, various of the internal components of the brewing system 10. As illustrated, the brewing system 10 includes a first tank 14 positioned distal to a second tank 16 within an interior region of the outer housing 12. The first tank 14 and the second tank 16 may be fluidly coupled through a fluid coupling system 30 positioned between the first tank 14 and the second tank 16. Additionally, the outer housing 12 may include an operator interface 31 arranged between the first tank 14 and the second tank 16. The operator interface 31 may be actuated by a user for selecting a recipe for brewing which may be linked with a software system of the brewing system 10 to cause automatic brewing of the selected recipe.

Further, each of the first tank 14 and the second tank 16 may have a respective cover configured for reversibly covering the first and second tanks 14, 16. More particularly, the first tank 14 has a cover 18 having a hinged connection with the outer housing 12 adjacent to the first tank 14. As illustrated best in FIGS. 1 and 2, the cover 18 is coupled with the outer housing 12 at a hinge assembly 20 such that the cover 18 may be hinged open over first tank 14 from the configuration shown in FIG. 1 to hinged closed over first tank 14 in the configuration shown in FIG. 2. The hinge assembly 20 may be manually actuated and/or automatically actuated through the operator interface 31. With reference still to FIGS. 1 and 2, the second tank 16 also includes a cover 22 having a hinged connection with the outer housing 12 adjacent to the second tank 16. Similar to the cover 18 of the first tank 14, the cover 22 is coupled with the outer housing 12 adjacent the second tank 16 through a hinge connection, namely a hinge assembly 24. In this way, the cover 22 may be manually and/or automatically actuated from the closed configuration of FIG. 1 to the open configuration illustrated in FIG. 2. The covers 18, 22 may be selectively opened when adding ingredients into the first and second tanks 14, 16 and/or when various contents of the first and second tanks 14, 16 are being boiled to allow vapor to be released from the first and second tanks 14, 16. Further, throughout the disclosure herein the first tank 14 may be referred to as the brew tank and the second tank 16 may be referred to as the lauter tank.

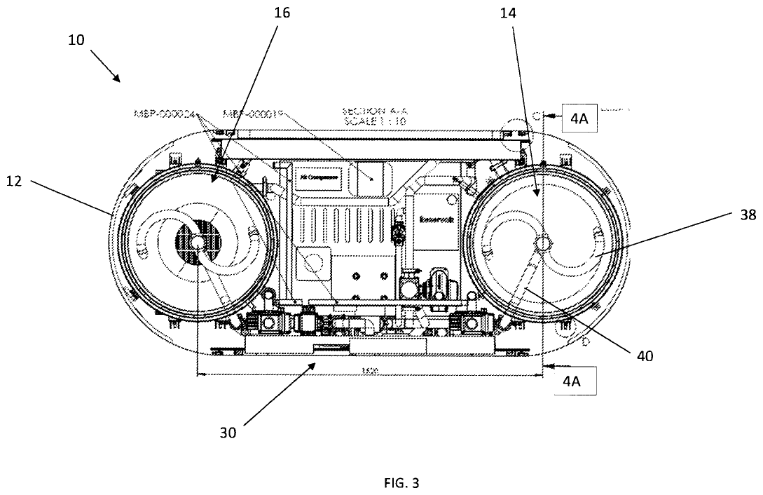

FIG. 3 illustrates a top view of the brewing system 10 without the covers 18, 22 arranged over the first and second tanks 14, 16. As illustrated, the first tank 14 and the second tank 16 are positioned distal to one another within outer housing 12, with the fluid coupling system 30 positioned therebetween.

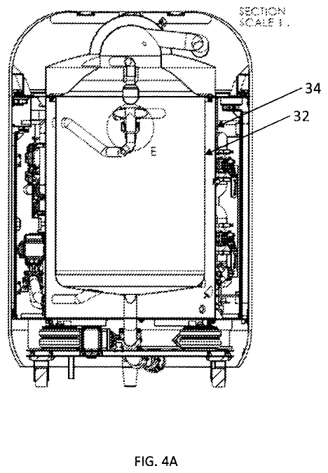

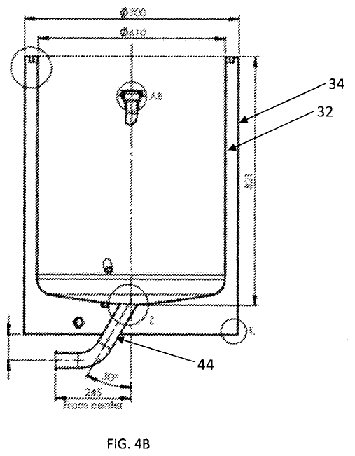

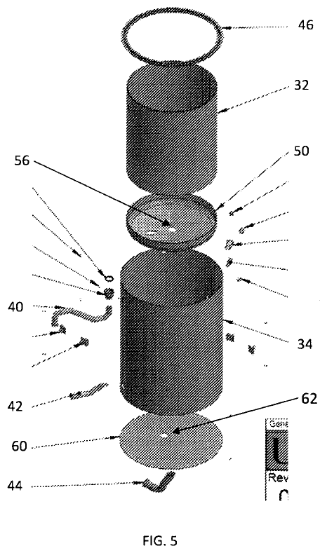

FIG. 4A illustrates a cross-sectional view of the brewing system 10, and more specifically of the first tank 14, taken along line 4-4 of FIG. 3. With reference to FIG. 4A, the first tank 14 will be described further herein. As illustrated, the first tank 14 may be composed of two separate cylinders such that the first tank 14 is defined by an inner cylinder 32 at least partially received within an outer cylinder 34. With reference to the exploded view of FIG. 5, the inner cylinder 32 and the outer cylinder 34 are shown further. The inner cylinder 32 may have a volume of approximately 304 liters and may be defined by a first cylinder wall having a wall thickness of approximately 2 mm. The outer cylinder 34 may have a volume of approximately 316 liters and be defined by a second cylinder wall having a wall thickness of approximately 2 mm. In this way, the first tank 14 may have volume of approximately 240 L, such that the first tank 14 has a brew capacity of 200 L. Additionally, each of the inner cylinder 32 and the outer cylinder 34 may be composed of stainless steel. As illustrated, the inner cylinder 32 is open at either end and defines a first opening extending through the first cylinder wall 36. The first opening may be configured for lateral alignment within a second opening extending through the second cylinder wall of the outer cylinder 34. In this way, the first opening and the second opening may be configured for receiving a component therethrough. As will be described further herein, the inner and/or the outer cylinders 32, 34 may comprise additional openings for receiving various other components of the brewing system 10.

Additionally, as illustrated in FIGS. 3-4B, the first tank 14 comprises a rotary arm 38 arranged therein. The rotary arm 38 may be coupled with an inlet pipe 40 which is configured for coupling the rotary arm 38 with the fluid coupling system 30. More particularly, the inlet pipe 40 may extend from the fluid coupling system 30 and through the outer cylinder 34 and the inner cylinder 32 to engage with the rotary arm 38. The engagement of the rotary arm 38 and the inlet pipe 40 will be described further herein with reference to FIGS. 7-9. As illustrated best in FIG. 4A, the rotary arm 38 and the inlet pipe 40 are both positioned within an upper portion of the first tank 14. For example, the rotary arm 38 and the inlet pipe 40 are both arranged within the upper half of the first tank 14 and towards a top surface of the first tank 14.

The brewing system 10 additionally includes an outlet pipe 42 which may fluidly couple the first tank 14 and the fluid coupling system 30 such that fluids may exit the first tank 14 through the outlet pipe 42. For example, during the process of brewing it may be desired for the fluids to exit the first tank 14 and enter the second tank 16 which may be facilitated by at least the outlet pipe 42. Additionally, the brewing system 10 includes a waste-water tank pipe 44 which is coupled with the first tank 14 at a bottommost portion of the first tank 14 and may be used for delivering fluids from the first tank 14 to a waste-water tank 11 (FIG. 2) during the process of brewing. More particularly, during the cleansing of the first tank 14 the waste-water and remaining fluid may exit into the waste-water tank 11 (FIG. 2) through the waste-water tank pipe 44. It will be appreciated that, in other examples, waste-water tank 11 may be omitted, such that waste-water is alternatively, or additionally, expelled through waste-water tank pipe 44 or another mechanism accordingly.

FIG. 4B illustrates an additional cross-sectional view of the first tank 14 of FIG. 3. In the illustrative embodiment of FIG. 4B, the inner cylinder 32 is arranged within the outer cylinder 34 and the outer cylinder 34 is illustrated having the waste-water tank pipe 44 disposed at least partially within the second cylinder wall of the outer cylinder 34. As illustrated, the waste-water tank pipe 44 is arranged such that at least a portion of the waste-water tank pipe 44, illustratively a main portion, is angled relative to the longitudinal axis L of the first tank 14. In some embodiments, the main portion is angled relative to the longitudinal axis L by an angle α having a value of approximately 30 degrees. The various pipes described herein provide mechanisms for fluidly coupling the first tank 14 with the fluid coupling system 30 and/or various other components of the system to ensure fluids may be delivered to and may exit the first tank 14 during the brewing process.

With reference to the exploded view of FIG. 5, the components of the first tank 14 will be described further. As illustrated, the first tank 14 includes the inner cylinder 32 and the outer cylinder 34, the inner cylinder 32 configured to be at least partially received within the outer cylinder 34. Further, arranged vertically above the inner cylinder 32, the first tank 14 may include a sealing ring 46 which may be used for creating a fluid tight seal between the first tank 14 and the cover 18 (FIG. 1) when the cover 18 (FIG. 3) is in the closed configuration. In some embodiments, the sealing ring 46 may be secured around an upper most perimeter of the inner cylinder 32. As previously described, the first tank 14 may include the inlet pipe 40 for reception of fluids (e.g., water) within the first tank 14. As illustrated, the inlet pipe 40 may be coupled with a joint arm 73 which may engage with a bearing 126 when the inlet pipe 40 is coupled with the rotary arm 38, as will be described further with reference to FIGS. 7-9.

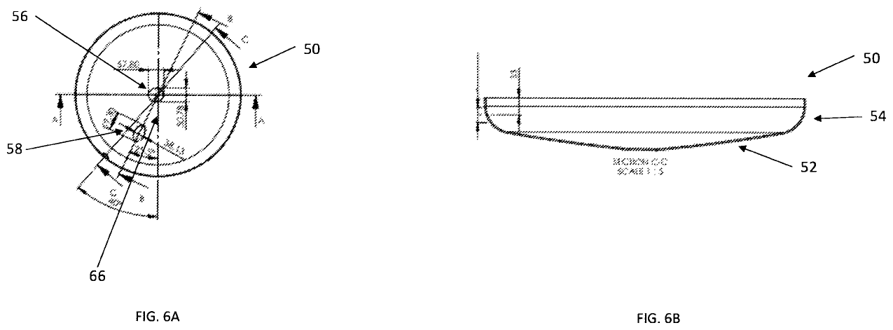

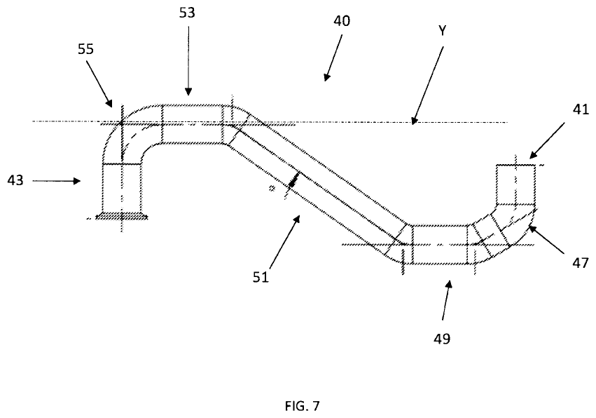

Additionally, the first tank 14 includes an inner cylinder base 50 which may be arranged at and coupled with a bottom end of the inner cylinder 32. The inner cylinder base 50 is illustrated and described further with reference to FIGS. 6A and 6B. More particularly, FIG. 6A is a top perspective view of the inner cylinder base 50 and FIG. 6B illustrates a cross sectional view of the inner cylinder base 50. The inner cylinder base 50 may be configured for at least partially enclosing the inner cylinder 32 to reduce undesired fluid egress from the inner cylinder 32. As illustrated in FIGS. 6A-6B, the inner cylinder base 50 has a bottom plate portion 52, a circular side wall 54 extending around an entirety of the bottom plate portion 52, a first borehole 56 arranged through the bottom plate portion 52 and a second borehole 58 arranged through the bottom plate portion 52. The first borehole 56 is illustrated as having a width W2 and a length L2. In some examples, the width W2 has a value of approximately 57.80 mm and the length L2 may have a value of approximately 50.78 mm. Further, the second borehole 58 may have a width W3 and a length L3. In some instances, the width may have a value of approximately 38.13 mm while the length L3 may have a value of approximately 69.30 mm. However, the above recited dimensions are provided as examples and other dimensions may be incorporated. In some embodiments, the side wall 54 may engage with a portion of the outer side of first cylinder wall 36 of the inner cylinder 32 while the bottom plate portion 52 may enclose the bottom of the inner cylinder 32. In this way, fluid egress is only allowed through the first and/or second boreholes 56, 58 of the inner cylinder base 50. More particularly, the first borehole 56 may be configured for receiving the outlet pipe 42 while the second borehole 58 may be configured for receiving the waste-water tank pipe 44.

With reference again to FIG. 5, in some embodiments, the first tank 14 may include an outer cylinder base 60 which may be configured for coupling with the bottommost portion of the outer cylinder 34 for enclosing the outer cylinder 34 and ensuring that fluid egress from the outer cylinder 34 is only through the piping, for example the outlet pipe 42 and/or the waste-water tank pipe 44. As illustrated, the outer cylinder base 60 is a circular plate having a borehole 62 extending therethrough, which may have a diameter of approximately 6.2 cm. The borehole 62 may be configured for receiving the waste-water tank pipe 44 to allow for fluid communication between the outer cylinder 34 and the waste-water tank 11 (FIG. 2). Further, in some embodiments, the borehole 62 of the outer cylinder base 60 may align with the first borehole 56 of the inner cylinder base 50 such that the waste-water tank pipe 44 may also be received into the inner cylinder 32 for direct reception into the inner cylinder 32, as previously described.

As previously disclosed, the inner cylinder 32 and the outer cylinder 34 may include various other openings for receiving components, such as fittings or piping, of the brewing system 10. For example, as best illustrated in FIG. 5, the outer cylinder 34 includes a plurality of openings within the second cylinder wall of the outer cylinder 34 for receiving various pipes and of the brewing system 10. In some embodiments, the brewing system 10 includes a fitting, illustratively a tri-clover clamp fitting, and a water drainpipe which may be received and fixed within the second cylinder wall of the outer cylinder 34 and configured to allow for water egress from the first tank 14. Further, as illustrated in FIG. 5, the brewing system 10 may also include a temperature sensor pipe and a liquid level sensor pipe, which may be used for coupling with a temperature sensor and a liquid level sensor, respectively, to monitor the temperature of the first tank 14 and the liquid level within the first tank 14 during the brewing process. Further, the brewing system 10 may also include a pressure outlet pipe, which may work with a pressure valve of the first tank 14 to monitor the pressure levels within the first tank 14 and allow for evaporation of boiling water during the brew process. More particularly, if evaporation of the boiling water during the brewing process is required, the system may indicate to the software system that the cover 18 should be opening through the hinge assembly 20 to allow for the vapor to escape the first tank 14.

In some embodiments, various other sensors may be incorporated in use with the first tank 14. In some embodiments, the first tank 14 additionally includes a plurality of mounting plates configured for mounting the first tank 14 to portions of the outer housing 12. For example, the mounting plates may engage with fasteners to couple with the outer housing 12 and secure the arrangement of the first tank 14 and the second tank 16 within the outer housing 12 of the brewing system 10. Further, while not shown, the first tank 14 may also include a plurality of heating strips arranged between the inner cylinder 32 and the outer cylinder 34 of the brew tank 14. In this way, the temperature of the first tank 14 may be adjusted during use of the first tank 14 for brewing the beer. For example, and as will be described further, the recipe may require for the first tank 14 to be heated to different temperatures thought the process of brewing. These temperatures may be automatically set through the brewing system 10 and the software system may allow for an automated actuation of the heating strips to increase to the desired temperatures. The plurality of heating strips may be composed of approximately four heating strips having a power of approximately 1200 Watts each. However, in other embodiments, any number of heating strips may be incorporated with varying wattage levels.

With reference now to FIGS. 7-9, the rotary arm 38 and the inlet pipe 40 will be described further herein. For example, FIG. 7 illustrates a cross-sectional side perspective view of the inlet pipe 40. As illustrated, the inlet pipe 40 has a first end 41 and a second end 43. The first end 41 may be configured for engagement with the rotary arm 38. Adjacent the first end 41, the inlet pipe 40 includes a first curved portion 47 which is coupled with a first connector piece 49. Further, the inlet pipe 40 includes an angled portion 51 which may be coupled with a second connector piece 53 such that the angled portion 51 is arranged between the first connector piece 49 and the second connector piece 53. The second end 43 is coupled with the second connector piece 53 through a second curved portion 55. As illustrated, the angled portion 51 extends at an angle of approximately 35 degrees relative to a horizontal axis Y. However, in other embodiments, the angled portion 51 may extend at an angle that is less then or greater than approximately 35 degrees.

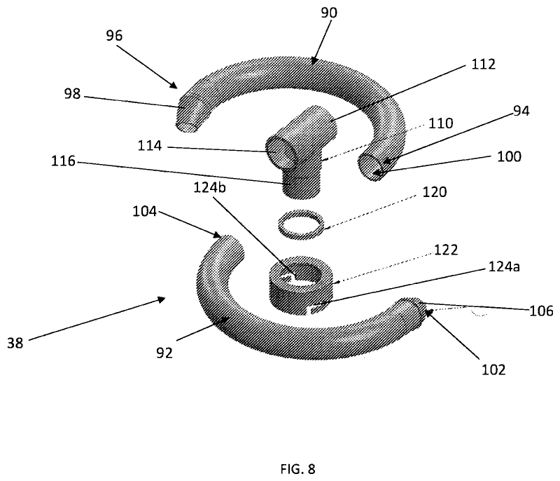

As illustrated best in the exploded view of FIG. 8, the rotary arm 38 includes a first curved pipe 90 and a second curved pipe 92. The first curved pipe 90 includes a first end 94 and a second end 96, the first end 94 having a narrowed portion 98. Further, as illustrated, the first curved pipe 90 is hollow such that a lumen 100 is defined as extending therethrough. With reference still to FIG. 8, the second curved pipe 92 also comprises a first end 102 and a second end 104 opposite the first end 102. As illustrated, the first end 102 comprises a narrowed portion 106. Further, the second curved pipe 92 is hollow such that a lumen (not shown) is extending therethrough. In this way, both the first curved pipe 90 and the second curved pipe 92 are capable of receiving fluid such that the fluid may enter and exit the rotary arm 38 through the first and second curved pipes 90, 92. More particularly, and as will be described further herein, the rotary arm 38 may be fluidly coupled with the inlet pipe 40 for receiving a fluid to cause rotation of the rotary arm 38 during operation.

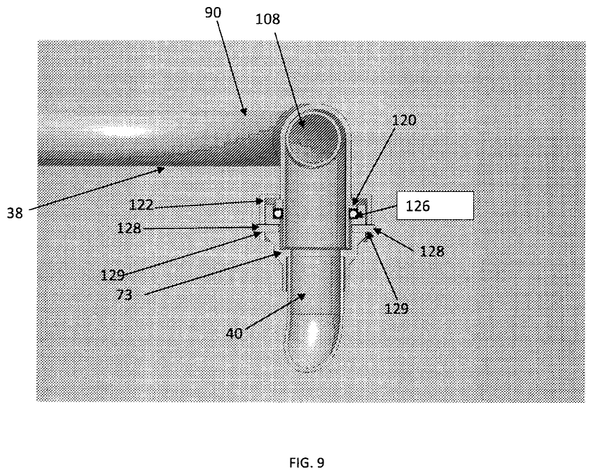

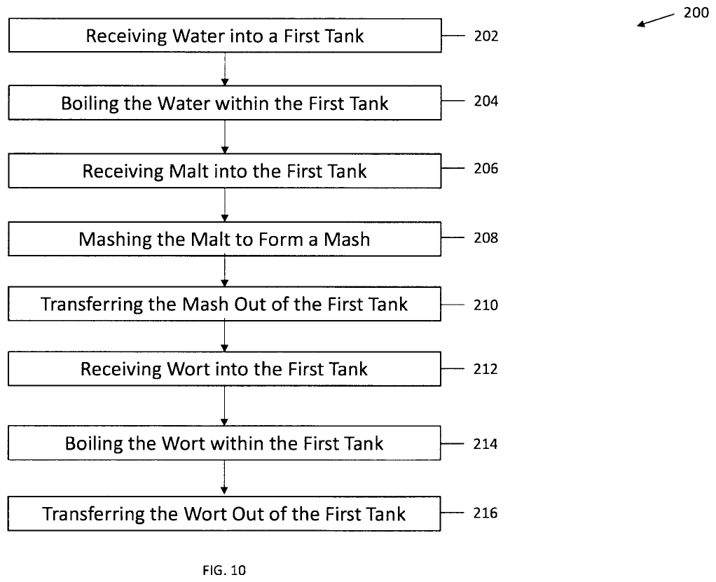

As illustrated in FIGS. 8 and 9, the rotary arm 38 is coupled to the inlet pipe 40 through a pipe coupler, illustratively a T-pipe coupler 110. The T-pipe coupler 110 includes a first pipe 112 having a first end 113 and a second end 114, and a bottom pipe 116 extending vertically downward from the first pipe 112. As illustrated, the second end 96 of the first curved pipe 90 may be received within the first end 113 of the first pipe 112 while the second end 104 of the second curved pipe 92 may be received within the second end 114 of the first pipe 112. The inlet pipe 40 may be received within the bottom pipe 116 of the T-pipe coupler 110. Further, the T-pipe coupler 110 may engage with a cover 122. In some embodiments, the cover 122 may be received over a portion of the bottom pipe 116 of the T-pipe coupler 110 prior to engagement with the inlet pipe 40. As illustrated, the cover 122 includes a first slot 124a and a second slot 124b which may facilitate allowing engagement between the cover 122 and the T-pipe coupler 110.

FIG. 9 illustrates a cross sectional view of the coupling between the inlet pipe 40 and the rotary arm 38 facilitated by the cover 122 and the T-pipe coupler 110. The rotary arm 38 is illustrates as extending within the T-pipe coupler 110. As illustrated, the cover 122 may be arranged around the bottom pipe 116 and the stopper ring 120 may be disposed around the bottom pipe 116 vertically below the cover 122 and in abutment with the cover 122. Further, as illustrated in FIG. 9, the T-pipe coupler 110 comprises a plurality of protrusions 128 which may engage with openings 129 of the joint arm 73 to couple the inlet pipe 40 and the joint arm 73. Further, the protrusions 128 may extend into the slots 124a, 124b of the cover 122 such that when the cover 122 is rotated into a locked position, the cover 122 and the T-pipe coupler 110 are fixed with one another. Additionally, a bearing 126 may be arranged below and in abutment with the stopper ring 120. In some examples, the bearing 126 is a Teflon bearing. The bearing 126 may function to reduce friction between the stopper ring 120, the joint arm 73, and the T-pipe coupler 110 during rotation of the rotary arm 38, and thus rotation of the T-pipe coupler 110. For example, inlet pipe 40 is fixed within the T-pipe coupler 110 with one or more T-clamps.

The above-recited fluid coupling between the T-pipe coupler 110 and the rotary arm 38 allows for fluid to enter into the rotary arm 38 to cause rotation of the rotary arm 38, causing an implosive and/or vortex effect within the first tank 14 during the fluid flow through the rotary arm 38. Depending on the phase of the brewing process, the rotation of the rotary arm 38 may have varying speeds, for example varying rotations per minute (rpm). More particularly, needle bearings (not shown) may allow for hydrodynamics to control the rotational speed of the rotary arm 38. The function of the brew tank 14 and its various components during steps of the brewing process will be described with reference to FIG. 10.

FIG. 10 is a flow chart illustrating a method of using a first tank 14 during a brewing process of a liquid, for example during the process of brewing beer. The steps described herein do not recite every step of the brewing process, but rather recite the steps that involve the first tank 14 more particularly. At block 202, the method 200 first includes receiving water into the first tank 14. In these embodiments, the water may be delivered through a hose which my coupled with the first tank 14. In some embodiments, between approximately 140 liters to approximately 160 liters of water may be delivered into the first tank 14. Further, the process of receiving the water into the first tank 14 may be an automated process controlling by the software system of the brewing system 10 in combination with the input from the operator interface 31. In some embodiments, the pH value of the water may be tested after it is transferred into the first tank 14. In some examples, the pH value of the water needs to be between approximately 4.2 and approximately 4.8. As such, if the pH value of the water is above 5 when tested, the water may be boiled until the pH value is within the target range of between approximately 4.2 and approximately 4.8.

At block 204, the method 200 further includes heating the water within the first tank 14 to a value of between approximately 42 degrees Celsius and approximately 52 degrees Celsius. At block 206, the method 200 further includes receiving malt into the first tank 14. This may be done manually by the user. The amount of malt delivered into the first tank 14 may depend on the recipe that has been chosen for brewing by the operator and may be indicated to the user by the operator interface 31 (FIG. 1).

At block 208, the method further includes mashing the malt. This step may be conducted automatically, such that the software system works to automate the operation of a plurality of different phases having parameters determined by the selected recipe. For example, in some embodiments, mashing the malt comprises a first phase for separating starch from sugars. During this phase, the rotary arm 38 is in substantially constant motion at a medium level speed. During this phase, the rotary arm 38 movement causes an impulsive vortex to cause the malt to move within the first tank 14. Further, an impeller pump, which may be a component of the fluid coupling system 30, may transfer the mash from the outlet pipe 42 back into the inlet pipe 40 and the rotary arm 38 to allow for continuous movement and mashing of the malt throughout the first tank 14. The speed, or rotations per minute, of the impeller pump may dictate the speed of the rotary arm 38. The rotations per minute of the impeller pump may be dictated by the recipe that is chosen by the user and may be an automated process. Lastly, during this step the first tank 14 may have a temperature value that is dictated by the recipe chosen by the user.

Once the first phase is completed, the mashing process moves into a second phase, which may be referred to as the protein phase. During this phase, the rotary arm 38 may be operated consistently at the medium level speed. The temperature may be increased to a specific temperature depending to the recipe that is chosen by the user. This temperature modification may be achieved through the actuation of the plurality of heating strips between the inner cylinder 32 and the outer cylinder 34. During this phase, the mash may be transferred through the outlet pipe 42 to the rotary arm 38 of the first tank 14 through the operation of the impeller pump in predetermined intervals according to the recipe that is chosen by the user. The amount of time that the mash may undergo this phase may be dictated by the recipe. Once this phase is completed, the mash may undergo a rest phase in order to allow for adjustment of the temperature of the brew tank 14. Similarly, the amount of time required for this phase and the temperature modification may be dictated by the recipe.

Once the rest phase is completed, the mash may undergo a third phase, which may be referred to as the sugar phase and the maltose rest phase. During this phase, the rotary arm 38 may be operated at a low level speed. Further, the temperature may be adjusted to a value that is determined by the recipe chosen by the user. Additionally, during this phase, the mash is transferred through the outlet pipe 42 and back into the rotary arm 38 through the impeller pump in order to ensure continuous motion of the mash. This may be conducted at intervals, the value of which determined by the recipe chosen by the user. After completion of the third phase, the mash may undergo a fourth phase within the brew tank 14.

The fourth phase may be referred to as the sugar phase and dextrose rest phase. During this process, the rotary arm 38 may be at rest (i.e., rotate at 0 rpm) and the temperature may be increased or decreased to a value determined by the recipe selected by the user. In this way, the temperature of the first tank 14 may be altered during this phase while the mash does not undergo movement within the first tank 14. After completion of the fourth phase, the mash may be tested for various properties. For example, the pH value, iodine levels, color, sugar content, and stability of the mash may be tested. If any of these values are not at the required level, the mash process may be repeated until the desired levels are met. For example, if the sugar content is too high, the entire mash process may be repeated to further lower the sugar content.

Further, as illustrated at block 210, once the mashing process is completed, the method 200 further includes transferring the mash out of the first tank 14. This may be done through the use of outlet pipe 42 and the fluid coupling system 30. In these embodiments, the mash may be transferred from the first tank 14 to the second tank 16 for further processing into a wort. In some embodiments, subsequent to transferring the mash out of the first tank 14, the first tank 14 may be cleaned. In embodiments, the first tank 14 is cleaned through the delivery of fluids and cleaning agents into and out of the first tank 14.

After cleaning of the first tank 14, the method 200 includes the step illustrated at block 212 including receiving wort into the first tank 14. As illustrated at block 214, the method 200 may include the step of boiling the wort and the water within the first tank 14. This may include raising the temperature of the first tank 14. The boiling step of block 214 may be conducted for approximately sixty minutes to approximately ninety minutes, however various other time values may be used as well. During this step, hops may be added to the first tank 14 manually by the user. The amount may be determined by the recipe chosen. Further, as illustrated at block 216, the method 200 further includes transferring the wort and the water out of the first tank 14. In some embodiments, this step includes transferring the wort and the water from the first tank 14 into the second tank 16 so that the boiled wort may then be chilled prior to undergoing a fermentation process. The remainder of the brewing process may be completed in various other components of the brewing system 10.

The above-described brew component, i.e., the first tank 14, cooperates with the remaining components of the brewing system 10 in order to create a brewing system 10 having several advantages and benefits over the standard equipment that is currently used for brewing beer. The first tank described herein allows for the mashing of the malt to be conducted within one tank and easily transferred to the second tank 16 through the fluid coupling system 30. Additionally, while described herein with reference only to the mashing of malt for the production of beer, the first tank 14 may be purposed for brewing of another liquid and/or another process such as distillation of a liquid.

The following clauses are provided as example aspects of the disclosed subject matter:

1. A component of a brewing system having an outer housing enclosing at least the component and a fluid coupling system, the component comprising: a tank including an inner cylinder disposed at least partially within an outer cylinder; a rotary arm disposed within an upper portion of the tank; an inlet pipe coupled with the rotary arm; and an outlet pipe fluidly coupled with the fluid coupling system of the brew system; wherein the tank component is configured for creating a mash.

2. The component of clause 1, wherein the first tank is fluidly coupled to a second tank within the outer housing through the fluid coupling system.

3. The component of clause 1, wherein the first tank has a volumetric capacity of approximately 240 liters.

4. The component of clause 1, wherein the inner cylinder and the outer cylinder are composed of stainless steel.

5. The component of clause 1, wherein the brewing system includes a first cover reversibly coupled with the first tank through a hinge assembly.

6. The component of clause 1, wherein the rotary arm is composed a first portion and a second portion and wherein each of the first portion and the second portion define a lumen extending therethrough.

7. The component of clause 6, wherein the inlet pipe is coupled with the rotary arm through a coupler such that the inlet pipe is configured for delivering a fluid into the lumen of the first portion and the second portion of the rotary arm.

8. The component of clause 7, wherein the T-pipe coupler comprises a first pipe adjacent a second pipe and a bottom pipe extending vertically below the first pipe and the second pipe, and wherein a stopper ring and a bearing are disposed around the bottom pipe.

9. The component of clause 1, wherein the outer cylinder comprises a first opening for receiving the outlet pipe to fluidly couple the first tank and the fluid coupling system within a bottom portion of the first tank.

10. The component of clause 9, wherein the outer cylinder comprises a second opening for receiving a waste-water tank pipe for fluidly coupling the first tank with a waste-water tank of the brewing system.

11. The component of clause 1, wherein the first tank comprises a temperature sensor pipe received at least partially therewithin for operation with a temperature sensor to monitor the temperature within the first tank.

12. The component of clause 1, wherein the first tank comprises a liquid level sensor pipe received at least partially within the first tank for operation with a liquid level sensor to monitor the liquid level within the first tank.

13. The component of clause 1, wherein the first tank includes a pressure outlet pipe received at least partially within the first tank for operation with a pressure sensor to monitor the pressure within the first tank.

14. A brewing system, comprising: a first tank arranged distal to a second tank and a fluid coupling system arranged between the first tank and the second tank, the first tank including: an inner cylinder disposed at least partially within an outer cylinder; a rotary arm arranged within an upper portion of the first tank; an inlet pipe fluidly coupled with the rotary arm and the fluid coupling system; an outlet pipe fluidly coupled with the fluid coupling system; and wherein the first tank has a volumetric capacity of approximately 240 liters.

15. The brewing system of clause 14, wherein rotary arm is comprised of a first portion and a second portion and wherein each of the first portion and the second portion comprises a lumen extending therethrough.

16. The brewing system of clause 1, wherein the first tank comprises an opening at a bottom surface of the first tank for coupling with a waste-water tank pipe for fluidly coupling the first tank with a waste-water tank of the brewing system.

17. A method of brewing a beverage using a brewing system, wherein the brewing system includes a first tank positioned distal to and fluidly coupled with a second tank, the method including: receiving water into the first tank; boiling the water within the first tank; receiving malt into the first tank; mashing the malt to form a mash; transferring the mash out of the first tank; receiving wort into the first tank; boiling the wort within the first tank; and transferring the wort out of the first tank.

18. The method of clause 17, further comprising: performing the mashing step automatically.

19. The method of clause 18, further comprising: cleaning the first tank after transferring the mash out of the first tank and prior to receiving the wort within the first tank.

20. The method of clause 18, wherein the boiling of the water within the first tank and boiling the wort and the water within the first tank are completed through heating the first tank with a plurality of heating strips arranged between an inner cylinder and an outer cylinder of the first tank.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided the description and illustration of the present application, one skilled in art may envision variations, modifications, and alternate aspects falling within the spirit of the broader aspects of the general inventive concept embodied in this application that do not depart from the broader scope of the claimed disclosure.

1. A component of a brewing system having an outer housing enclosing at least the component and a fluid coupling system, the component comprising:
a tank including an inner cylinder disposed at least partially within an outer cylinder;
a rotary arm disposed within an upper portion of the tank;
an inlet pipe coupled with the rotary arm; and
an outlet pipe fluidly coupled with the fluid coupling system of the brew system;
wherein the tank component is configured for creating a mash.

2. The component of claim 1, wherein the first tank is fluidly coupled to a second tank within the outer housing through the fluid coupling system.

3. The component of claim 1, wherein the first tank has a volumetric capacity of approximately 240 liters.

4. The component of claim 1, wherein the inner cylinder and the outer cylinder are composed of stainless steel.

5. The component of claim 1, wherein the brewing system includes a first cover reversibly coupled with the first tank through a hinge assembly.

6. The component of claim 1, wherein the rotary arm is composed a first portion and a second portion and wherein each of the first portion and the second portion define a lumen extending therethrough.

7. The component of claim 6, wherein the inlet pipe is coupled with the rotary arm through a coupler such that the inlet pipe is configured for delivering a fluid into the lumen of the first portion and the second portion of the rotary arm.

8. The component of claim 7, wherein the T-pipe coupler comprises a first pipe adjacent a second pipe and a bottom pipe extending vertically below the first pipe and the second pipe, and wherein a stopper ring and a bearing are disposed around the bottom pipe.

9. The component of claim 1, wherein the outer cylinder comprises a first opening for receiving the outlet pipe to fluidly couple the first tank and the fluid coupling system within a bottom portion of the first tank.

10. The component of claim 9, wherein the outer cylinder comprises a second opening for receiving a waste-water tank pipe for fluidly coupling the first tank with a waste-water tank of the brewing system.

11. The component of claim 1, wherein the first tank comprises a temperature sensor pipe received at least partially therewithin for operation with a temperature sensor to monitor the temperature within the first tank.

12. The component of claim 1, wherein the first tank comprises a liquid level sensor pipe received at least partially within the first tank for operation with a liquid level sensor to monitor the liquid level within the first tank.

13. The component of claim 1, wherein the first tank includes a pressure outlet pipe received at least partially within the first tank for operation with a pressure sensor to monitor the pressure within the first tank.

14. A brewing system, comprising:
a first tank arranged distal to a second tank and a fluid coupling system arranged between the first tank and the second tank, the first tank including:
an inner cylinder disposed at least partially within an outer cylinder;
a rotary arm arranged within an upper portion of the first tank;
an inlet pipe fluidly coupled with the rotary arm and the fluid coupling system;
an outlet pipe fluidly coupled with the fluid coupling system; and
wherein the first tank has a volumetric capacity of approximately 240 liters.

15. The brewing system of claim 14, wherein rotary arm is comprised of a first portion and a second portion and wherein each of the first portion and the second portion comprises a lumen extending therethrough.

16. The brewing system of claim 1, wherein the first tank comprises an opening at a bottom surface of the first tank for coupling with a waste-water tank pipe for fluidly coupling the first tank with a waste-water tank of the brewing system.

17. A method of brewing a beverage using a brewing system, wherein the brewing system includes a first tank positioned distal to and fluidly coupled with a second tank, the method including:
receiving water into the first tank;
boiling the water within the first tank;
receiving malt into the first tank;
mashing the malt to form a mash;
transferring the mash out of the first tank;
receiving wort into the first tank;
boiling the wort within the first tank; and
transferring the wort out of the first tank.

18. The method of claim 17, further comprising:
performing the mashing step automatically.

19. The method of claim 18, further comprising:
cleaning the first tank after transferring the mash out of the first tank and prior to receiving the wort within the first tank.

20. The method of claim 18, wherein the boiling of the water within the first tank and boiling the wort and the water within the first tank are completed through heating the first tank with a plurality of heating strips arranged between an inner cylinder and an outer cylinder of the first tank.
